(19) United States
(12) Patent Application Publication
(10) Pub. No.: US 2023/0384570 A1
(43) Pub. Date: Nov. 30, 2023

(54) ZOOM LENS AND IMAGE PICKUP APPARATUS HAVING THE SAME

(71) Applicant: CANON KABUSHIKI KAISHA, Tokyo (JP)

(72) Inventor: Shunji IWAMOTO, Tochigi (JP)

(21) Appl. No.: 18/321,051

(22) Filed: May 22, 2023

(30) Foreign Application Priority Data
May 31, 2022 (JP) 2022-088496

(51) Int. Cl. G02B 15/14; G02B 13/02

(52) U.S. Cl. CPC G02B 15/144105; G02B 13/02

(57) ABSTRACT

A zoom lens consists of, in order from an object side to an image side, a front lens unit, intermediate and rear groups. The front lens unit has positive refractive power. The intermediate group includes a plurality of lens units and has a negative combined focal length at a wide-angle end. The rear group includes, in order from the object side to the image side, a first rear lens unit having positive refractive power, a second rear lens unit having negative refractive power, and a third rear lens unit having positive refractive power, and a fourth rear lens unit having negative refractive power. A distance between adjacent lens units changes during zooming. During zooming, the front lens unit, the first rear lens unit, and the third rear lens unit are fixed relative to an image plane. During focusing, the second rear lens unit moves relative to the image plane.

### BACKGROUND

### Technical Field

One of the aspects of the disclosure relates to a zoom lens, suitable for digital video cameras, digital still cameras, broadcasting cameras, film-based cameras, surveillance cameras, and the like.

### Description of Related Art

A zoom lens for an image pickup apparatus is demanded to have a compact size, light weight, ability to satisfactorily correct various aberrations including chromatic aberration, and high optical performance. In addition, the zoom lens is demanded to have a long focal length at the telephoto end, a small F-number, and a large aperture ratio. Moreover, the zoom lens is demanded to have a large zoom ratio (magnification variation ratio) and to be easy to manufacture.

Japanese Patent Laid-Open No. 2021-76830 discloses a zoom lens that achieves a long focal length and a large aperture ratio by placing a lens unit having positive refractive power at a position closest to the object.

However, the zoom lens described in Japanese Patent Laid-Open No. 2021-76830 tends to have large aberrations including chromatic aberration, and has difficulty in having high optical performance. In a case where the refractive power of each lens unit in the zoom lens is weakened in order to satisfactorily correct aberrations, the zoom lens becomes larger. In a case where aberration is corrected by increasing the number of lens units in the zoom lens, the mechanical mechanism becomes complicated and the zoom lens becomes larger.

### SUMMARY

One of the aspects of the present disclosure provides a zoom lens having a long focal length, a large aperture ratio, a small size, light weight, and high optical performance.

A zoom lens according to one aspect of the disclosure consists of, in order from an object side to an image side, a front lens unit, an intermediate group, and a rear group. The front lens unit has positive refractive power. The intermediate group includes a plurality of lens units and has a negative combined focal length at a wide-angle end. The rear group includes, in order from the object side to the image side, a first rear lens unit having positive refractive power, a second rear lens unit having negative refractive power, and a third rear lens unit having positive refractive power, and a fourth rear lens unit having negative refractive power. A distance between adjacent lens units changes during zooming. During zooming, the front lens unit, the first rear lens unit, and the third rear lens unit are fixed relative to an image plane. During focusing, the second rear lens unit moves relative to the image plane. An image pickup apparatus having the above zoom lens also constitutes another aspect of the disclosure.

Further features of the disclosure will become apparent from the following description of embodiments with reference to the attached drawings.

### BRIEF DESCRIPTION OF THE DRAWINGS

FIG. 1 is a sectional view of a zoom lens according to Example 1.

FIG. 2A is an aberration diagram of the zoom lens according to Example 1 at a wide-angle end, and FIG. 2B is an aberration diagram of the zoom lens according to Example 1 at a telephoto end.

FIG. 3 is a sectional view of a zoom lens according to Example 2.

FIG. 4A is an aberration diagram of the zoom lens according to Example 2 at a wide-angle end, and FIG. 4B is an aberration diagram of the zoom lens according to Example 2 at the telephoto end.

FIG. 5 is a sectional view of a zoom lens according to Example 3.

FIG. 6A is an aberration diagram of the zoom lens according to Example 3 at a wide-angle end, and FIG. 6B is an aberration diagram of the zoom lens according to Example 3 at the telephoto end.

FIG. 7 is a sectional view of a zoom lens according to Example 4.

FIG. 8A is an aberration diagram of the zoom lens according to Example 4 at a wide-angle end, and FIG. 8B is an aberration diagram of the zoom lens according to Example 4 at the telephoto end.

FIG. 9 is a sectional view of a zoom lens according to Example 5.

FIG. 10A is an aberration diagram of the zoom lens according to Example 5 at a wide-angle end, and FIG. 10B is an aberration diagram of the zoom lens according to Example 5 at the telephoto end.

FIG. 11 is a schematic view of an image pickup apparatus.

### DESCRIPTION OF THE EMBODIMENTS

Referring now to the accompanying drawings, a description will be given of zoom lenses according to examples of the disclosure and an image pickup apparatus having one of the zoom lenses.

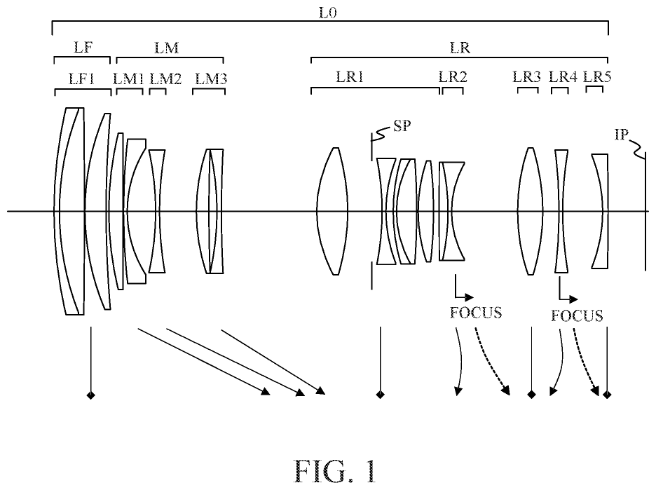

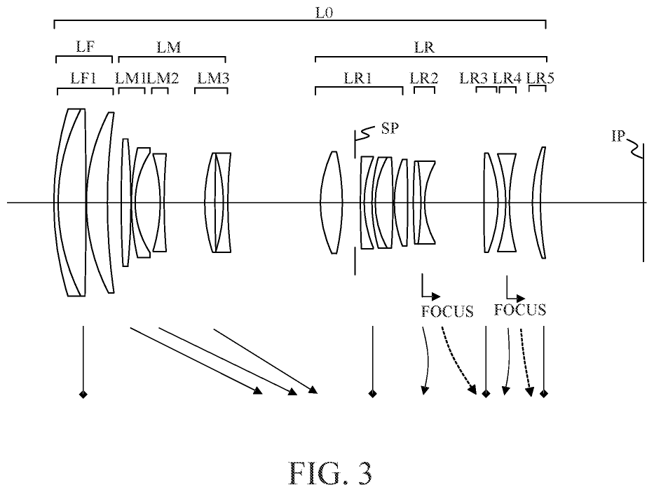

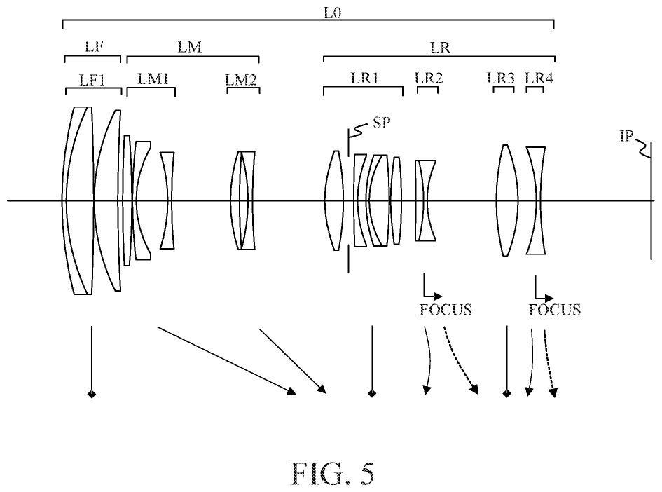

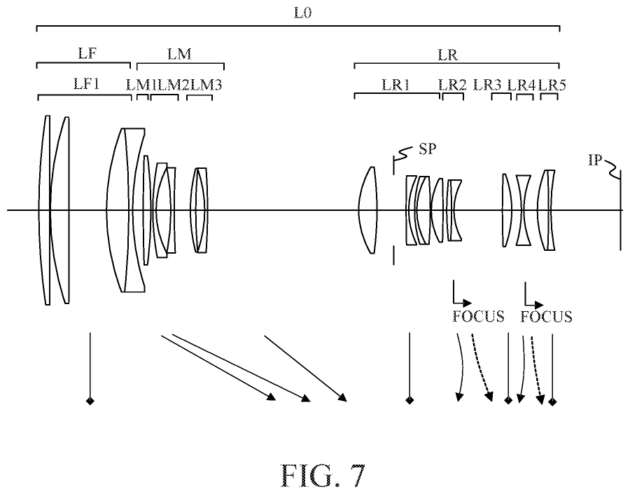

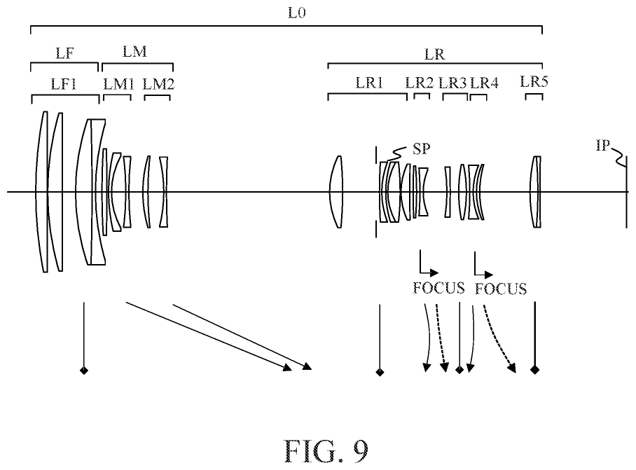

FIGS. 1, 3, 5, 7, and 9 are sectional views of zoom lenses L0 according to Examples 1 to 5, respectively, in in-focus states at infinity. The zoom lens L0 according to each example is used for an image pickup apparatus such as a digital video camera, a digital still camera, a broadcasting camera, a film-based camera, a surveillance camera, and the like.

In each lens sectional view, a left side is an object side (front) and a right side is an image side (back). The zoom lens L0 according to each example includes a plurality of lens units. In the specification of this application, a lens unit is one lens or a group of lenses that move or stand still during zooming. That is, in the zoom lens L0 according to each example, a distance between adjacent lens units changes during zooming from the wide-angle end to the telephoto end. The lens unit may include one or more lenses. The lens unit may include an aperture stop SP.

The zoom lens L0 according to each example consists of, in order from the object side to the image side, a front group LF, an intermediate group (or middle unit) LM, and a rear group LR.

In each lens sectional view, LFi represents an i-th (i is a natural number) lens unit counted from the object side among the lens units included in the front group LF. LMi represents an i-th (i is a natural number) lens unit counted from the object side among the lens units included in the intermediate group LM. LRi represents an i-th (i is a natural number) lens unit counted from the object side among the lens units included in the rear group LR.

SP denotes an aperture stop (diaphragm), and the aperture stop SP determines (limits) a light beam (luminous flux) of the open F-number (Fno). IP is an image plane. In a case where the zoom lens L0 according to each example is used as an imaging optical system of a digital still camera or a digital video camera, an imaging plane of a solid image sensor (photoelectric conversion sensor) such as a CCD sensor or a CMOS sensor is placed on the image plane IP. In a case where the zoom lens L0 according to each example is used as an imaging optical system of a film-based camera, a photosensitive plane corresponding to the film plane is placed on the image plane IP.

In each lens sectional view, an arrow indicates a moving locus (trajectory) of each lens unit during zooming from the wide-angle end to the telephoto end. A solid-line arrow represents the movement of the lens unit during zooming from the wide-angle end to the telephoto end at the infinity object distance, and a dashed-line arrow represents the movement of the lens unit during zooming from the wide-angle end to the telephoto end at a short object distance. An arrow relating to focusing indicates a moving direction of the lens unit during focusing from an infinity object to a short distance object (from infinity to near).

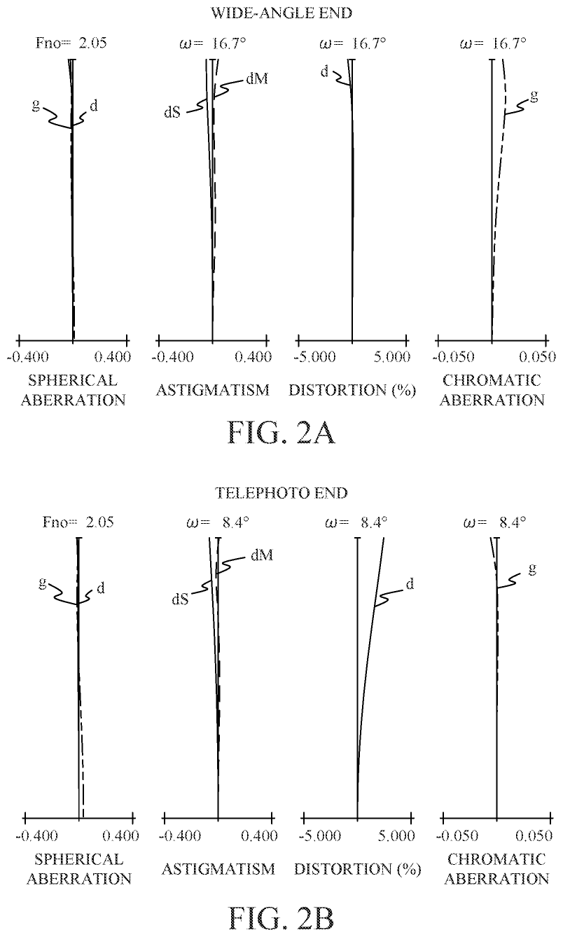

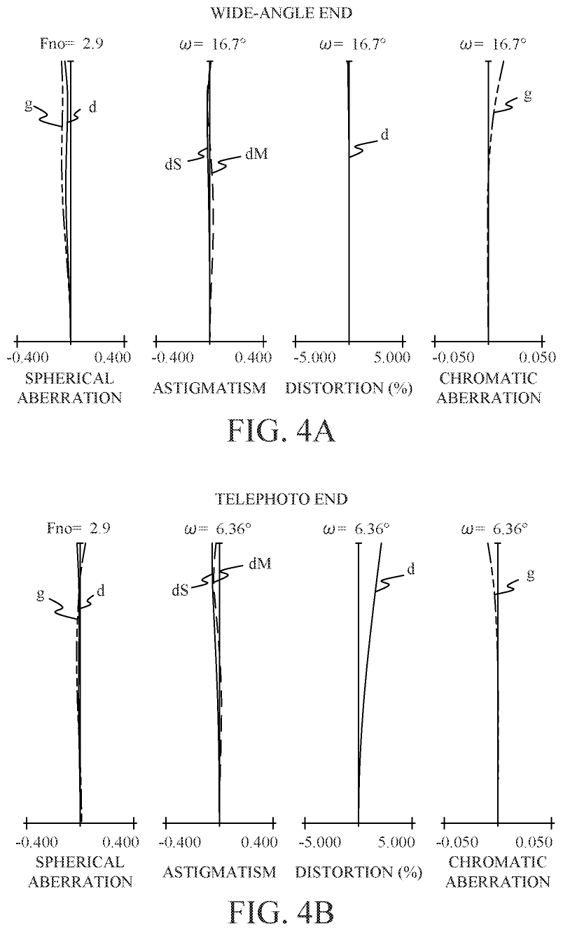

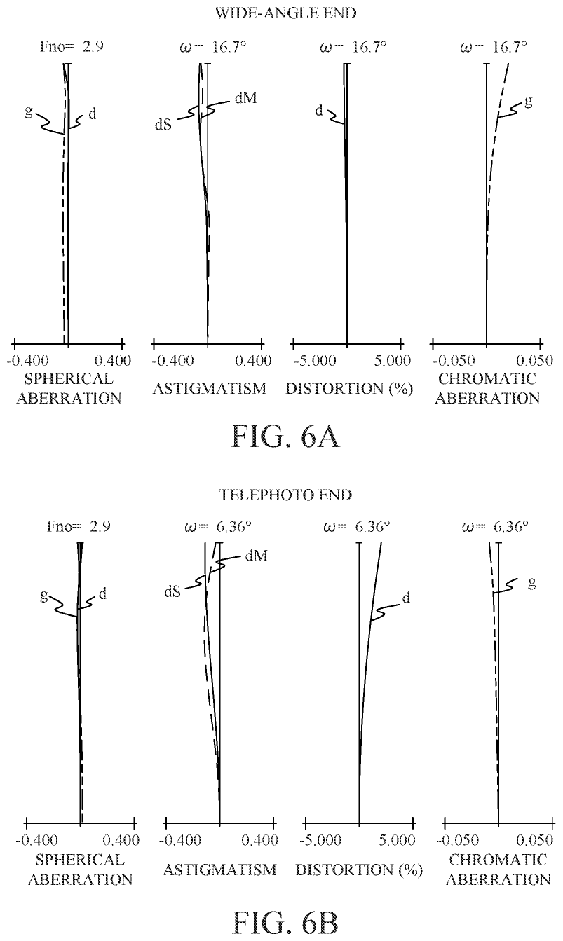

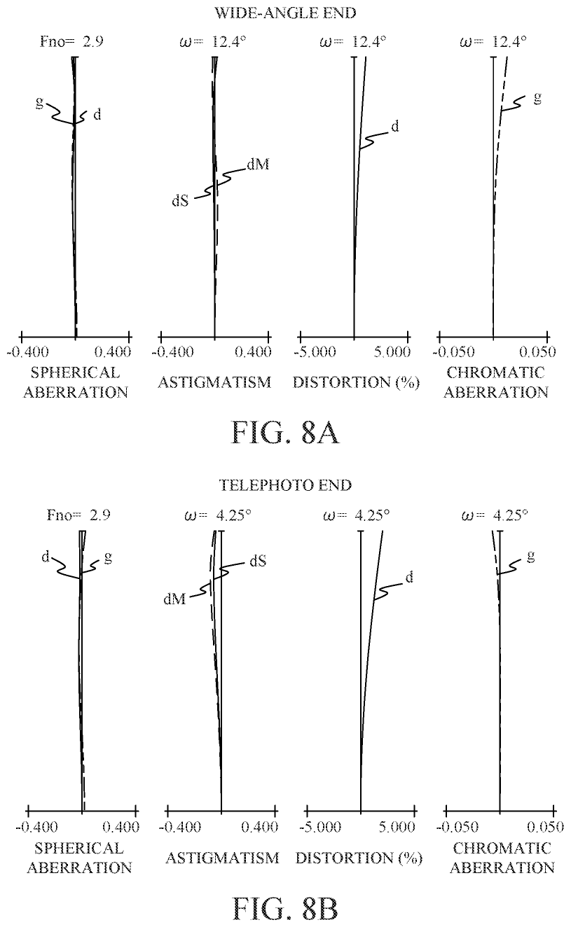

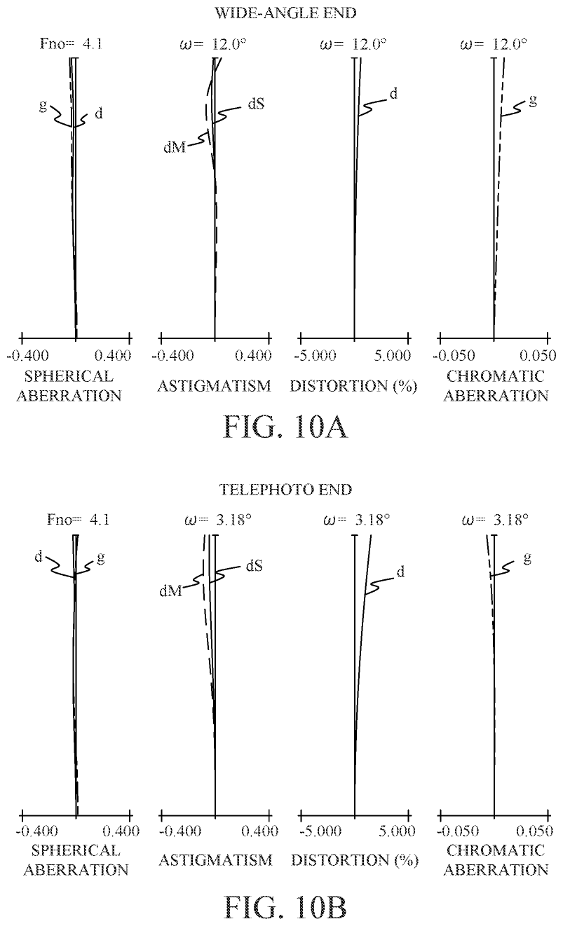

FIGS. 2A and 2B, FIGS. 4A and 4B, FIGS. 6A and 6B, FIGS. 8A and 8B, and FIGS. 10A and 10B are aberration diagrams of the zoom lenses L0 according to Examples 1 to 5, respectively, in the in-focus states at infinity. In each aberration diagram, FIGS. 2A, 4A, 6A, 8A, and 10A are aberration diagrams at the wide-angle end, and FIGS. 2B, 4B, 6B, 8B, and 10B are aberration diagrams at the telephoto end. In the spherical aberration diagram, Fno denotes an F-number. The spherical aberration diagram indicates spherical aberration amounts for the d-line (wavelength 587.6 nm) and g-line (wavelength 435.8 nm). In the astigmatism diagram, dS indicates an astigmatism amount on a sagittal image plane, and dM indicates an astigmatism amount on a meridional image plane. The distortion diagram illustrates a distortion amount for the d-line. The chromatic aberration diagram illustrates a chromatic aberration amount for the g-line. ω is an imaging half angle of view (°) by paraxial calculation.

A description will now be given of a characteristic configuration of the zoom lens L0 according to each example.

In order to obtain a zoom lens L0 having a long focal length, a large aperture ratio, a small size, light weight, and high optical performance, the arrangement of the lens units of the zoom lens L0 is to be properly set.

The zoom lens L0 according to each example consists of, in order from the object side to the image side, a front group LF, an intermediate group LM, and a rear group LR. The zoom lens L0 consists of a plurality of lens units, and a distance between adjacent lens units changes during zooming.

In the zoom lens L0 according to each example, the front group LF consists of a positive refractive power lens unit (first front side lens unit) LF1. Disposing the lens unit LF1 having positive refractive power closest to the object can easily provide the zoom lens L0 with a so-called telephoto type power arrangement, which is beneficial to achieving a long focal length. The lens unit LF1 is fixed relative to the image plane IP during zooming. The zoom lens L0 having a long focal length and a large aperture ratio tends to have a large front lens diameter. The lens unit LF1 fixed relative to the image plane IP can simplify a holding mechanism of the front group LF and easily reduce the size of the zoom lens L0.

In the zoom lens L0 according to each example, the intermediate group LM consists of a plurality of lens units including at least two lens units. The intermediate group LM has a negative combined focal length at the wide-angle end. The intermediate group LM having negative refractive power is a main magnification varying unit, and each lens unit moves while changing a distance between adjacent lens units during zooming. Each lens unit moving while changing the distance between adjacent lens units during zooming can effectively correct various aberrations during zooming, particularly zoom fluctuations of lateral chromatic aberration and astigmatism.

In the zoom lens L0 according to each embodiment, the rear group LR includes, in order from the object side to the image side, a lens unit LR1 having positive refractive power, a lens unit LR2 having negative refractive power, a lens unit LR3 having positive refractive power, and a lens unit LR4 having negative refractive power. The lens unit LR1 will be referred to as a first rear lens unit. The lens unit LR2 will be referred to as a second rear lens unit. The lens unit LR3 will be referred to as a third rear lens unit. The lens unit LR4 will be called a fourth rear lens unit. The lens units LR1 and LR3 are fixed relative to image plane IP during zooming. The rear group LR as a whole constitutes a relay unit. Fixing the lens units LR1 and LR3 relative to the image plane IP can simplify a holding mechanism of the rear group LR, and easily reduce the size of the zoom lens L0. Moving the lens units LR2 and LR4 during zooming can easily suppress peak movement and aberration fluctuation during zooming. The positive lens units, which tend to be relatively heavy, are set as fixed units, and the negative lens units, which tend to be relatively lightweight, are set as movable units. This configuration can easily simplify the mechanical mechanism for moving the movable units, and easily reduce the size reduction of the zoom lens L0. Setting the lens units LR1 and LR2 to a telephoto power arrangement, and setting the lens units LR3 and LR4 to a telephoto power arrangement are beneficial to shortening the overall lens length of the zoom lens L0, and can easily reduce the size of the zoom lens L0.

A description will now be given of one or more configurations that may be satisfied in the zoom lens L0 according to each example.

In the zoom lens L0 according to each example, the lens unit LR2 may move along a locus convex toward the image side during zooming from the wide-angle end to the telephoto end. Thereby, the focus movement can be satisfactorily corrected during zooming. Here, the convex locus of the lens unit A toward the image side means that a moving amount of the lens unit A in an in-focus state at infinity from the wide-angle end has a maximum value in an intermediate area during zooming while a sign of the moving amount toward the image side is set to a positive value.

In the zoom lens L0 according to each example, the lens unit LR4 may move along a locus convex toward the image side during zooming from the wide-angle end to the telephoto end. Thereby, the focus movement can be satisfactorily corrected during zooming.

In the zoom lens L0 according to each embodiment, the lens unit LR2 may be moved toward the image side during focusing from infinity to a short distance. The configuration that fixes the lens unit located on the object side, whose lens diameter tends to be large, during focusing and provides focusing using part of the subsequent units whose lens diameters are small can easily reduce the weight of the focus lens unit. Moving the lens unit LR2, which moves during zooming, also during focusing can share the driving mechanism for the lens unit LR2, and simplify the configuration. Thereby, the size of the zoom lens L0 can be reduced.

In the zoom lens L0 according to each example, the lens unit LR4 may be moved toward the image side during focusing from infinity to a short distance. The configuration that fixes the lens unit located on the object side, whose lens diameter tends to be large, during focusing and provides focusing part of the subsequent units, whose lens diameters are small can easily reduce the weight of the focus lens unit. Moving the lens unit LR4, which moves during zooming, also during focusing, can share the driving mechanism for the lens unit LR4, and simplify the configuration. Thereby, the size of the zoom lens L0 can be easily reduced.

A description will now be given of the conditions that the zoom lens L0 according to each example may satisfy. The zoom lens L0 according to each example may satisfy one or more of the following inequalities (1) to (18):

0.414<fLF1/ft<1.434 (1)

−1.158<βLMw<−0.285 (2)

−4.158<βLMt<−1.200 (3)

0.966<βLR4t/βLR4w<1.064 (4)

0.100<DMRw/fw<1.273 (5)

0.177<DFMt/fLF1<0.466 (6)

0.050<fLR1/ft<0.461 (7)

−0.632<fLR2/ft<−0.060 (8)

0.149<fLR3/ft<0.405 (9)

−1.14<fLR4/ft<−0.04 (10)

0.100<skw/fw<0.755 (11)

0.639<Lt/ft<1.764 (12)

−2.140<(1−βLR2w²)βLR2Rw²/Fnow<−0.351 (13)

−1.010<(1−βLR4w²)βLR4Rw²/Fnow<−0.115 (14)

0.290<DLR1/fw<0.697 (15)

0.028<TLR2/fw<0.074 (16)

0.014<DLR3/fw<0.166 (17)

0.001<TLR4/fw<0.052 (18)

Here, fLF1 is a focal length of lens unit LF1. ft is a focal length of the zoom lens L0 in an in-focus state at infinity at the telephoto end. βLMw is a combined imaging lateral magnification of the intermediate group LM in an in-focus state at infinity at the wide-angle end. βLMt is a combined imaging lateral magnification of the intermediate group LM in an in-focus state at infinity at the telephoto end. βLR4t is an imaging lateral magnification of lens unit LR4 in an in-focus state at infinity at the telephoto end. βLR4w is an imaging lateral magnification of the lens unit LR4 in an in-focus state at infinity at the wide-angle end. DMRw is a distance on the optical axis from a lens surface closest to the image plane of the intermediate group LM to a lens surface closest to the object of the rear group LR at the wide-angle end. fw is a focal length of the zoom lens L0 in an in-focus state at infinity at the wide-angle end. DFMt is a distance on the optical axis from a lens surface closest to the image plane of the front group LF to a lens surface closest to the object of the intermediate group LM at the telephoto end. fLR1 is a focal length of lens unit LR1. fLR2 is a focal length of lens unit LR2. fLR3 is a focal length of lens unit LR3. fLR4 is a focal length of lens unit LR4. skw is a distance on the optical axis from a lens surface closest to the image plane of the rear group LR to the image plane IP at the wide-angle end. Lt is a distance on the optical axis from a lens surface closest to the object of the front group LF to the image plane IP at the telephoto end. βLR2w is an imaging lateral magnification of the lens unit LR2 in an in-focus state at infinity at the wide-angle end. βLR2Rw is a combined imaging lateral magnification of all lens units disposed on the image side of the lens unit LR2 in an in-focus state at infinity at the wide-angle end. Fnow is an F-number of the zoom lens L0 in an in-focus state at infinity at the wide-angle end. βLR4Rw is a combined imaging lateral magnification of all lens units disposed on the image side of the lens unit LR4 in an in-focus state at infinity at the wide-angle end. DLR1 is a distance on the optical axis from a lens surface closest to the object of the lens unit LR1 to a lens surface closest to the image plane of the lens unit LR1. TLR2 is a sum of the thicknesses on the optical axis of all lenses in the lens unit LR2. DLR3 is a distance on the optical axis from a lens surface closest to the object of lens unit LR3 to a lens surface closest to the image plane of lens unit LR3. TLR4 is a sum of the thicknesses on the optical axis of all lenses in the lens unit LR4.

Inequality (1) defines a relationship between the focal length of the lens unit LF1 and the focal length of the zoom lens L0 at the telephoto end. In a case where the focal length of the lens unit LF1 increases and the value fLF1/ft becomes higher than the upper limit of inequality (1), the lens unit LF1 becomes larger. In a case where the focal length of the lens unit LF1 is reduced and the value fLF1/ft becomes lower than the lower limit of inequality (1), correction of various aberrations, especially lateral chromatic aberration at the telephoto end becomes difficult.

Inequality (2) defines the combined imaging lateral magnification of the intermediate group LM at the wide-angle end. In a case where the value βLMw becomes higher than the upper limit of inequality (2), it becomes easier to increase the magnification variation burden of the intermediate group LM, which is beneficial to achieving a high magnification variation ratio of the zoom lens L0, but correction of various aberrations, particularly astigmatism at the wide-angle end, becomes difficult. In a case where the value βLMw becomes lower than the lower limit of inequality (2), it becomes difficult to achieve a high magnification variation ratio of the zoom lens L0.

Inequality (3) defines the combined imaging lateral magnification of the intermediate group LM at the telephoto end. In a case where the value βLMt becomes higher than the upper limit of inequality (3), it becomes difficult to achieve a high zoom ratio of the zoom lens L0. In a case where the value βLMt becomes lower than the lower limit of inequality (3), the magnification variation burden of the intermediate group LM tends to increase, which is beneficial to achieving a high magnification variation ratio of the zoom lens L0 but correction of various aberrations, such as spherical aberration at a telephoto end, becomes difficult.

Inequality (4) defines a relationship between the imaging lateral magnification of the lens unit LR4 at the wide-angle end and the imaging lateral magnification of the lens unit LR4 at the telephoto end. In a case where the value βLR4t/βLR4w becomes higher than the upper limit of inequality (4), it is beneficial to achieving a high magnification variation ratio of the zoom lens L0, but it becomes difficult to correct various aberrations, especially astigmatism at the telephoto end. In a case where the value βLR4t/βLR4w becomes lower than the lower limit of inequality (4), it is difficult to achieve the high magnification variation ratio of the zoom lens L0.

Inequality (5) defines a ratio between the distance between the intermediate group LM and the rear group LR at the wide-angle end and the focal length of the zoom lens L0 at the wide-angle end. In a case where the distance between the intermediate group LM and the rear group LR at the wide-angle end increases and the value DMRw/fw becomes higher than the upper limit of inequality (5), the size of the zoom lens L0 increases. In a case where the value DMRw/fw becomes lower than the lower limit of inequality (5), it becomes difficult to achieve a high magnification ratio of the zoom lens L0. Here, In a case where an aperture plane is disposed between the lens units, the distance is calculated without the aperture plane.

Inequality (6) defines a relationship between the distance between the front group LF and the intermediate group LM at the telephoto end and the focal length of the lens unit LF1. In a case where the distance between the front group LF and the intermediate group LM at the telephoto end increases and the value DFMt/fLF1 becomes higher than the upper limit of inequality (6), the size of the zoom lens L0 increases. In a case where the distance between the front group LF and the intermediate group LM at the telephoto end decreases and the value DFMt/fLF1 becomes lower than the lower limit of inequality (6), it becomes difficult to reduce the lens diameter of the intermediate group LM, and the size of the zoom lens L0 increases. Here, in a case where the aperture plane is disposed between the lens units, the distance is calculated without the aperture plane.

Inequality (7) defines a relationship between the focal length of the lens unit LR1 and the focal length of the zoom lens L0 at the telephoto end. In a case where the focal length of the lens unit LR1 increases and the value fLR1/ft is higher than the upper limit of inequality (7), it becomes difficult to reduce the overall length of the zoom lens L0, and the size of the zoom lens L0 increases. In a case where the focal length of the lens unit LR1 decreases and the value fLR1/ft becomes lower than the lower limit of inequality (7), correction of various aberrations, especially longitudinal chromatic aberration and spherical aberration at the telephoto end becomes difficult.

Inequality (8) defines a relationship between the focal length of the lens unit LR2 and the focal length of the zoom lens L0 at the telephoto end. In a case where the focal length of the lens unit LR2 increases and the value fLR2/ft becomes higher than the upper limit of inequality (8), that is, in a case where the absolute value of the focal length of the lens unit LR2 decreases, it becomes difficult to correct various aberrations, especially coma at the telephoto end. In a case where the focal length of the lens unit LR2 decreases the value fLR2/ft becomes lower than the lower limit of inequality (8), that is, in a case where the absolute value of the focal length of the lens unit LR2 increases, the size of the zoom lens L0 increases.

Inequality (9) defines a relationship between the focal length of the lens unit LR3 and the focal length of the zoom lens L0 at the telephoto end. In a case where the focal length of the lens unit LR3 increases and the value fLR3/ft becomes higher than the upper limit of inequality (9), it becomes difficult to reduce the overall length of the zoom lens L0, and the size of the zoom lens L0 increases. In a case where the focal length of the lens unit LR1 decreases and the value fLR3/ft becomes lower than the lower limit of inequality (9), it becomes difficult to correct various aberrations, especially curvature of field at the wide-angle end.

Inequality (10) defines a relationship between the focal length of the lens unit LR4 and the focal length of the zoom lens L0 at the telephoto end. In a case where the focal length of the lens unit LR4 increases and the value fLR4/ft becomes higher than the upper limit of inequality (10), that is, in a case where the absolute value of the focal length of the lens unit LR4 decreases, correction of various aberrations, especially distortion at the telephoto end becomes difficult. In a case where the focal length of the lens unit LR4 decreases and the value fLR4/ft becomes lower than the lower limit of inequality (10), that is, in a case where the absolute value of the focal length of the lens unit LR4 increases, the size of the zoom lens L0 becomes larger.

Inequality (11) defines a relationship between the back focus of the zoom lens L0 at the wide-angle end and the focal length of the zoom lens L0 at the wide-angle end. In a case where the back focus becomes long and the value skw/fw becomes higher than the upper limit of inequality (11), the overall lens length of the zoom lens L0 becomes longer and the size of the zoom lens L0 becomes larger. In a case where the back focus becomes short and the value skw/fw becomes lower than the lower limit of inequality (11), the diameter of a lens closest to the image plane tends to increase, and the size of the zoom lens L0 increases. Here, in a case where a flat plate or the like is disposed on the image side of the lens, which has refractive power and is closest to the image plane, the back focus is calculated in terms of air.

Inequality (12) defines a relationship between the overall lens length of the zoom lens L0 at the telephoto end and the focal length of the zoom lens L0 at the telephoto end. In a case where the overall lens length of the zoom lens L0 increases and the value Lt/ft is higher than the upper limit of inequality (12), the diameter of the front lens increases and the size of the zoom lens L0 increases. In a case where the overall lens length of the zoom lens L0 is reduced and the value Lt/ft is lower than the lower limit of inequality (12), it is difficult to correct various aberrations, especially lateral chromatic aberration and curvature of field at the telephoto end. Here, in a case where a flat plate or the like is disposed on the image side of the lens which has refractive power and is disposed closest to the image plane, the overall lens length is calculated in terms of air.

Inequality (13) defines a relationship among the imaging lateral magnification of lens unit LR2 at the wide-angle end, the combined imaging lateral magnification of all lens units disposed on the image side of the lens unit LR2, and the F-number of zoom lens L0. In a case where the value (1−βLR2w²)βLR2Rw²/Fnow becomes higher than the upper limit of inequality (13), the absolute value of the focus sensitivity of lens unit LR2 becomes too small, and focus correction during zooming becomes insufficient, or a moving amount of the lens unit LR2 required for focus correction during zooming becomes larger. Thereby, the size of the zoom lens L0 increases. In a case where the value (1−βLR2w²)βLR2Rw²/Fnow is lower than the lower limit of inequality (13), the focus sensitivity of the lens unit LR2 becomes too high, the driving mechanism for driving the lens unit LR2 becomes complicated, and the size of the zoom lens L0 increases. Here, the focus sensitivity is a ratio of the moving amount of the lens unit to the moving amount of the focal plane in a case where the lens unit moves on the optical axis.

Inequality (14) defines a relationship among the imaging lateral magnification of lens unit LR4 at the wide-angle end, the combined imaging lateral magnification of all lens units disposed on the image side of lens unit LR4, and the F-number of zoom lens L0. In a case where the value (1-βLR4w²)βLR4Rw²/Fnow is higher than the upper limit of inequality (14), the absolute value of the focus sensitivity of lens unit LR4 becomes too small, focus correction during zooming becomes insufficient, or a moving amount of the lens unit LR4 increases necessary for focus correction during zooming increases. Thereby, the size of the zoom lens L0 increases. In a case where the value (1−βLR4w²)βLR4Rw²/Fnow is lower than the lower limit of inequality (14), the focus sensitivity of the lens unit LR4 becomes too high, the driving mechanism for driving the lens unit LR4 becomes complicated, and the size of the zoom lens L0 increases.

Inequality (15) defines a relationship between the distance on the optical axis from the lens surface closest to the object of lens unit LR1 to the lens surface closest to the image plane of lens unit LR1 and the focal length of zoom lens L0 at the wide-angle end. In a case where the value DLR1/fw is higher than the upper limit of inequality (15), the size of the zoom lens L0 increases. In a case where the value DLR1/fw is lower than the lower limit of inequality (15), it becomes difficult to correct various aberrations, especially spherical aberration at the telephoto end.

Inequality (16) defines a relationship between the sum of the thicknesses on the optical axis of all lenses of the lens unit LR2 and the focal length of the zoom lens L0 at the wide-angle end. In a case where the value TLR2/fw is higher than the upper limit of inequality (16), the weight of the lens unit LR2 increases, the driving mechanism for the lens unit LR2 becomes complicated, and the size of the zoom lens L0 increases. In a case where the value TLR2/fw is lower than the lower limit of inequality (16), lens processing becomes difficult and shape accuracy tends to become unstable. In particular, the image quality deteriorates due to manufacturing errors at the telephoto end.

Inequality (17) defines a relationship between the distance on the optical axis from the lens surface closest to the object of the lens unit LR3 to the lens surface closest to the image plane of the lens unit LR3 and the focal length of the zoom lens L0 at the wide-angle end. In a case where the value DLR3/fw is higher than the upper limit of inequality (17), the size of the zoom lens L0 increases. In a case where the value DLR3/fw is lower than the lower limit of inequality (17), correction of various aberrations, especially coma at the wide-angle end becomes difficult.

Inequality (18) defines a relationship between the sum of the thicknesses on the optical axis of all lenses of the lens unit LR4 and the focal length of the zoom lens L0 at the wide-angle end. In a case where the value TLR4/fw is higher than the upper limit of inequality (18), the weight of the lens unit LR4 increases, the driving mechanism of the lens unit LR4 becomes complicated, and the size of the zoom lens L0 increases. In a case where the value TLR4/fw is lower than the lower limit of inequality (18), lens processing becomes difficult and shape accuracy tends to become unstable.

Inequalities (1) to (18) may be replaced with inequalities (1a) to (18a) below:

0.541<fLF1/ft<1.306 (1a)

−1.049<βLMw<−0.394 (2a)

−3.741<βLMt<−1.300 (3 a)

0.978<βLR4t/βLR4w<1.052 (4a)

0.219<DMRw/fw<1.122 (5a)

0.214<DFMt/fLF1<0.430 (6a)

0.081<fLR1/ft<0.407 (7a)

−0.55<fLR2/ft<−0.08 (8a)

0.181<fLR3/ft<0.373 (9a)

−0.978<fLR4/ft<−0.060 (10a)

0.12<skw/fw<0.66 (11a)

0.780<Lt/ft<1.624 (12a)

−1.916<(1−βLR2w²)βLR2Rw²/Fnow<−0.574 (13a)

−0.898<(1−βLR4w²)βLR4Rw²/Fnow<−0.227 (14a)

0.341<DLR1/fw<0.647 (15a)

0.034<TLR2/fw<0.068 (16a)

0.033<DLR3/fw<0.147 (17a)

0.006<TLR4/fw<0.045 (18a)

Inequalities (1) to (18) may be replaced with inequalities (1b) to (18b) below:

0.605<fLF1/ft<1.242 (1b)

−0.995<βLMw<−0.449 (2b)

−3.532<βLMt<−1.449 (3b)

0.984<βLR4t/βLR4w<1.046 (4b)

0.294<DMRw/fw<1.047 (5b)

0.232<DFMt/fLF1<0.412 (6b)

0.108<fLR1/ft<0.380 (7b)

−0.508<fLR2/ft<−0.100 (8b)

0.197<fLR3/ft<0.357 (9b)

−0.896<fLR4/ft<−0.082 (10b)

0.143<skw/fw<0.613 (11b)

0.850<Lt/ft<1.553 (12b)

−1.805<(1−βLR2w²)βLR2Rw²/Fnow<−0.686 (13b)

−0.842<(1−βLR4w²)βLR4Rw²2/Fnow<−0.283 (14b)

0.366<DLR1/fw<0.621 (15b)

0.037<TLR2/fw<0.065 (16b)

0.042<DLR3/fw<0.137 (17b)

0.010<TLR4/fw<0.042 (18b)

A detailed description will now be given of the zoom lens L0 according to each example.

The zoom lens L0 according to Example 1 consists of, in order from the object side to the image side, a front group LF, an intermediate group LM, and a rear group LR. The front group LF consists of a lens unit LF1 having positive refractive power. The lens unit LF1 is fixed relative to the image plane IP during zooming. The intermediate group LM consists of, in order from the object side to the image side, a lens unit LM1 having negative refractive power, a lens unit LM2 having negative refractive power, and a lens unit LM3 having positive refractive power. The lens unit LM1, the lens unit LM2, and the lens unit LM3 move on different loci while changing the distance between adjacent lens units during zooming. The rear group LR includes, in order from the object side to the image side, a lens unit LR1 having positive refractive power, a lens unit LR2 having negative refractive power, a lens unit LR3 having positive refractive power, a lens unit LR4 having negative refractive power, and a lens unit LR5 having negative refractive power. The lens unit LR5 will be referred to as a fifth rear lens unit. The lens units LR1, LR3, and LR5 are fixed relative to the image plane IP during zooming. The lens units LR2 and LR4 move during zooming, and the distance between adjacent lens units changes during zooming. The lens unit LR1 includes an aperture stop SP. During focusing from infinity to a short distance, the lens unit LR2 moves toward the image side, and the lens unit LR4 moves toward the image side.

The zoom lens L0 according to Example 2 consists of, in order from the object side to the image side, a front group LF, an intermediate group LM, and a rear group LR. The front group LF consists of a lens unit LF1 having positive refractive power. The lens unit LF1 is fixed relative to the image plane IP during zooming. The intermediate group LM consists of, in order from the object side to the image side, a lens unit LM1 having negative refractive power, a lens unit LM2 having negative refractive power, and a lens unit LM3 having positive refractive power. The lens unit LM1, the lens unit LM2, and the lens unit LM3 move on different loci while changing the distance between the adjacent lens units during zooming. The rear group LR includes, in order from the object side to the image side, a lens unit LR1 having positive refractive power, a lens unit LR2 having negative refractive power, a lens unit LR3 having positive refractive power, a lens unit LR4 having negative refractive power, and a lens unit LR5 having positive refractive power. The lens units LR1, LR3, and LR5 are fixed relative to the image plane IP during zooming. The lens units LR2 and LR4 move during zooming, and a distance between adjacent lens units changes during zooming. The lens unit LR1 includes an aperture stop SP. During focusing from infinity to a short distance, the lens unit LR2 moves toward the image side, and the lens unit LR4 moves toward the image side.

The zoom lens L0 according to Example 3 consists of, in order from the object side to the image side, a front group LF, an intermediate group LM, and a rear group LR. The front group LF consists of a lens unit LF1 having positive refractive power. The lens unit LF1 is fixed relative to the image plane IP during zooming. The intermediate group LM consists of, in order from the object side to the image side, a lens unit LM1 having negative refractive power, and a lens unit LM2 having positive refractive power. The lens units LM1 and LM2 move on different loci while changing the distance between them during zooming. The rear group LR consists of, in order from the object side to the image side, a lens unit LR1 having positive refractive power, a lens unit LR2 having negative refractive power, a lens unit LR3 having positive refractive power, and a lens unit LR4 having negative refractive power. The lens units LR1 and LR3 are fixed relative to the image plane IP during zooming. The lens units LR2 and LR4 move during zooming, and a distance between adjacent lens units changes during zooming. The lens unit LR1 includes an aperture stop SP. During focusing from infinity to a short distance object, the lens unit LR2 moves toward the image side, and the lens unit LR4 moves toward the image side.

The zoom lens L0 according to Example 4 consists of, in order from the object side to the image side, a front group LF, an intermediate group LM, and a rear group LR. The front group LF consists of a lens unit LF1 having positive refractive power. The lens unit LF1 is fixed relative to the image plane IP during zooming. The intermediate group LM consists of, in order from the object side to the image side, a lens unit LM1 having positive refractive power, a lens unit LM2 having negative refractive power, and a lens unit LM3 having negative refractive power. The lens units LM1, LM2, and LM3 move on different loci while changing the distance between adjacent lens units during zooming. The rear group LR includes, in order from the object side to the image side, a lens unit LR1 having positive refractive power, a lens unit LR2 having negative refractive power, a lens unit LR3 having positive refractive power, a lens unit LR4 having negative refractive power, and a lens unit LR5 having positive refractive power. The lens units LR1, LR3, and LR5 are fixed relative to the image plane IP during zooming. The lens units LR2 and LR4 move during zooming, and a distance between adjacent lens units changes during zooming. The lens unit LR1 includes an aperture stop SP. During focusing from infinity to a short distance object, the lens unit LR2 moves toward the image side, and the lens unit LR4 moves toward the image side.

The zoom lens L0 according to Example 5 consists of, in order from the object side to the image side, a front group LF, an intermediate group LM, and a rear group LR. The front group LF consists of a lens unit LF1 having positive refractive power. The lens unit LF1 is fixed relative to the image plane IP during zooming. The intermediate group LM consists of, in order from the object side to the image side, a lens unit LM1 having negative refractive power and a lens unit LM2 having negative refractive power. The lens units LM1 and LM2 move on different loci while changing the distance between them during zooming. The rear group LR includes, in order from the object side to the image side, a lens unit LR1 having positive refractive power, a lens unit LR2 having negative refractive power, a lens unit LR3 having positive refractive power, a lens unit LR4 having negative refractive power, and a lens unit LR5 having positive refractive power. The lens units LR1, LR3, and LR5 are fixed relative to the image plane IP during zooming. The lens units LR2 and LR4 move during zooming, and a distance between adjacent lens units changes during zooming. The lens unit LR1 includes an aperture stop SP. During focusing from infinity to a short distance, the lens unit LR2 moves toward the image side, and the lens unit LR4 moves toward the image side.

In the zoom lenses L0 according to Examples 1 to 5, all optical surfaces having refractive power are refractive surfaces. Thereby, optical performance can be acquired with less manufacturing difficulty that is equivalent to or better than that of a diffractive optical element or a reflective surface in a case where an optical surface is made of the diffractive optical element or the reflective surface.

The zoom lenses L0 according to Examples 1 to 5 can achieve image stabilization by moving part of the zoom lens L0 in a direction having a component in the direction orthogonal to the optical axis. In particular, a lens unit, which has a relatively small diameter and is placed on the image side, is used as the part to be moved during image stabilization, so that an actuator for driving it can be made compact, and a lens apparatus including the zoom lens L0 can be made compact.

A description will now be given of numerical examples 1 to 5 corresponding to Examples 1 to 5.

In surface data in each numerical example, r represents a radius of curvature of each optical surface, and d (mm) is an on-axis distance (distance on the optical axis) between an m-th surface and an (m+1)-th surface, where m is a surface number counted from the light incident side. nd represents a refractive index for the d-line of each optical member, and νd represents an Abbe number of the optical member based on the d-line. The Abbe number νd of a certain material is expressed as follows:

νd=(Nd−1)/(NF−NC)
where Nd, NF, and NC are refractive indices based on the d-line (587.6 nm), the F-line (486.1 nm), and the C-line (656.3 nm) in the Fraunhofer line, respectively.

In each numerical example, values of all of d, focal length (mm), F-number, and half angle of view (°) are acquired in a case where the zoom lens L0 according to each example is an in-focus state on an infinity object. “Back focus BF” is a distance on the optical axis from the final lens surface (lens surface closest to the image plane) of the zoom lens L0 to the paraxial image plane expressed in air conversion length. The “overall lens length” is a length obtained by adding the back focus to a distance on the optical axis from the frontmost lens surface (the lens surface closest to the object) of the zoom lens L0 to the final lens surface. The “lens unit” includes one or more lenses.

In a case where the optical surface is an aspherical surface, an asterisk * is attached to the right side of the surface number. The aspherical shape is expressed as follows:

X=(h²/R)/[1+{1−(1+k)(h/R)²}^{1/2}]+A4×h⁴+A6×h⁶+A8×h⁸+A10×h¹⁰+A12×h¹²
where X is a displacement amount from a surface vertex in the optical axis direction, h is a height from the optical axis in a direction orthogonal to the optical axis, a light traveling direction is set positive, R is a paraxial radius of curvature, k is a conic constant, and A4, A6, A8, A10, and A12 are aspherical coefficients. “e±XX” in each aspheric coefficient means “×10^{±XX}”.

### Numerical Example 1

UNIT: mm
Surface Data

| Surface No. | r | d | nd | vd |
|---|---|---|---|---|
| 1 | 165.007 | 2.00 | 1.77047 | 29.7 |
| 2 | 102.210 | 9.19 | 1.43875 | 94.7 |
| 3 | −2836.692 | 0.17 | | |
| 4 | 92.024 | 7.79 | 1.49700 | 81.5 |
| 5 | 419.169 | (variable) | | |
| 6 | 119.719 | 5.24 | 1.69895 | 30.1 |
| 7 | −9119.138 | 0.13 | | |
| 8 | 222.608 | 1.40 | 1.59522 | 67.7 |
| 9 | 43.169 | (variable) | | |
| 10 | −102.107 | 1.40 | 1.59522 | 67.7 |
| 11 | 127.029 | (variable) | | |
| 12 | 70.978 | 4.61 | 1.95375 | 32.3 |
| 13 | 551.675 | 2.99 | | |
| 14 | −100.875 | 1.60 | 1.83481 | 42.7 |
| 15 | 411.903 | (variable) | | |
| 16* | 44.710 | 11.44 | 1.43875 | 94.7 |
| 17* | −71.025 | 8.85 | | |
| 18 (aperture stop) | ∞ | 3.75 | | |
| 19 | −99.516 | 1.40 | 1.65412 | 39.7 |
| 20 | 51.804 | 2.68 | | |
| 21 | 66.454 | 1.20 | 1.85478 | 24.8 |
| 22 | 38.396 | 7.49 | 1.76450 | 49.1 |
| 23* | −209.796 | 0.48 | | |
| 24 | 57.306 | 5.70 | 1.49700 | 81.5 |
| 25 | −149.817 | (variable) | | |
| 26 | 5546.126 | 3.24 | 1.92286 | 20.9 |
| 27 | −80.703 | 1.30 | 1.63980 | 34.5 |
| 28 | 34.856 | (variable) | | |
| 29* | 77.507 | 9.26 | 1.76450 | 49.1 |
| 30* | −71.565 | (variable) | | |
| 31 | −170.418 | 1.30 | 1.61800 | 63.4 |
| 32 | 130.262 | (variable) | | |
| 33 | −54.506 | 2.00 | 1.56883 | 56.4 |
| 34 | −900.480 | (variable) | | |
| image plane | ∞ | | | |

Aspheric Data
16th Surface
K = 0.00000e+00 A4 = −1.40533e−06 A6 = −1.37186e−10 A8 = −2.50564e−13
17th Surface
K = 0.00000e+00 A4 = 1.84457e−06 A6 = −5.84368e−10 A8= 1.81459e−13
23rd Surface
K = 0.00000e+00 A4 = 7.76781e−07 A6 = 4.20243e−10 A8 = −4.52171e−13
29th Surface
K = 0.00000e+00 A4 = 1.06625e−06 A6 = 2.14195e−10 A8 = −4.48782e−13
30th Surface
K = 0.00000e+00 A4 = 1.30655e−06 A6 = −3.60951e−10 A8 = −4.14141e−13
A10 = 2.69960e−16
Various Data

| | |
|---|---|
| Zoom Ratio | 2.03 |

| | Wide-Angle | Intermediate | Telephoto |
|---|---|---|---|
| Focal Length | 72.10 | 102.58 | 146.49 |
| FNo | 2.05 | 2.05 | 2.05 |
| Half Angle of View (°) | 16.70 | 11.91 | 8.40 |
| Image Height | 21.64 | 21.64 | 21.64 |
| Overall Lens Length | 217.31 | 217.31 | 217.31 |
| BF | 13.71 | 13.71 | 13.71 |
| d5 | 0.99 | 24.11 | 44.60 |
| d9 | 10.45 | 11.69 | 12.84 |
| d11 | 13.53 | 5.80 | 1.61 |
| d15 | 35.03 | 18.40 | 0.94 |
| d25 | 2.04 | 2.31 | 0.83 |
| d28 | 24.27 | 24.00 | 25.48 |
| d30 | 5.98 | 5.46 | 0.99 |
| d32 | 14.71 | 15.24 | 19.71 |
| d34 | 13.71 | 13.71 | 13.71 |

Zoom Lens Unit Data

| Lens Unit | Starting Surface | Focal Length |
|---|---|---|
| 1 | 1 | 172.74 |
| 2 | 6 | −204.55 |
| 3 | 10 | −94.89 |
| 4 | 12 | 463.78 |
| 5 | 16 | 51.74 |
| 6 | 26 | −68.38 |
| 7 | 29 | 50.02 |
| 8 | 31 | −119.27 |
| 9 | 33 | −102.08 |

### Numerical Example 2

UNIT: mm
Surface Data

| Surface No. | r | d | nd | vd |
|---|---|---|---|---|
| 1 | 115.694 | 1.60 | 1.72047 | 34.7 |
| 2 | 74.988 | 10.27 | 1.43875 | 94.7 |
| 3 | −1590.880 | 0.16 | | |
| 4 | 71.857 | 7.74 | 1.43387 | 95.1 |
| 5 | 229.206 | (variable) | | |
| 6 | 389.572 | 3.67 | 1.61340 | 44.3 |
| 7 | −224.087 | 0.12 | | |
| 8 | 90.573 | 1.40 | 1.59522 | 67.7 |
| 9 | 33.897 | (variable) | | |
| 10 | −60.561 | 1.40 | 1.59410 | 60.5 |
| 11 | 203.142 | (variable) | | |
| 12 | 59.142 | 3.77 | 1.85478 | 24.8 |
| 13 | 453.435 | 3.11 | | |
| 14 | −58.814 | 1.60 | 1.62041 | 60.3 |
| 15 | 148.393 | (variable) | | |
| 16* | 40.715 | 8.14 | 1.49700 | 81.5 |
| 17* | −75.250 | 4.67 | | |
| 18 (aperture stop) | ∞ | 1.97 | | |
| 19 | 382.638 | 1.40 | 1.77047 | 29.7 |
| 20 | 42.520 | 2.86 | | |
| 21 | 60.178 | 1.20 | 1.85478 | 24.8 |
| 22 | 33.812 | 6.57 | 1.76450 | 49.1 |
| 23* | −213.080 | 0.48 | | |
| 24 | 43.774 | 4.96 | 1.53775 | 74.7 |
| 25 | −350.467 | (variable) | | |
| 26 | 205.352 | 2.84 | 1.92286 | 20.9 |
| 27 | −108.404 | 1.30 | 1.75700 | 47.8 |
| 28 | 29.208 | (variable) | | |
| 29* | 5250.944 | 5.21 | 1.76450 | 49.1 |
| 30* | −44.832 | (variable) | | |
| 31 | −54.992 | 1.30 | 1.64769 | 33.8 |
| 32 | 66.879 | (variable) | | |
| 33 | 59.424 | 2.95 | 2.00100 | 29.1 |
| 34 | 114.407 | (variable) | | |
| image plane | ∞ | | | |

Aspheric Data
16th Surface
K = 0.00000e+00 A4 = −2.31070e−06 A6 = −6.94530e−10 A8 = −2.38664e−13
17th Surface
K = 0.00000e+00 A4 = 2.02846e−06 A6 = −1.46198e−09 A8 = 9.00137e−13
23rd Surface
K = 0.00000e+00 A4 = 7.16919e−07 A6 = 6.86451e−10 A8 = −1.34064e−12
29th Surface
K = 0.00000e+00 A4 = 2.50842e−06 A6 = 4.78254e−11 A8 = 6.47138e−13
30th Surface
K = 0.00000e+00 A4 = 2.28696e−06 A6 = −1.15709e−09 A8 = 1.22768e−12
A10 = −4.49859e−16
Various Data

| | |
|---|---|
| Zoom Ratio | 2.69 |

| | Wide-Angle | Intermediate | Telephoto |
|---|---|---|---|
| Focal Length | 72.12 | 118.22 | 194.03 |
| FNo | 2.90 | 2.90 | 2.90 |
| Half Angle of View (°) | 16.70 | 10.37 | 6.36 |
| Image Height | 21.64 | 21.64 | 21.64 |
| Overall Lens Length | 217.47 | 217.47 | 217.47 |
| BF | 37.98 | 37.98 | 37.98 |
| d5 | 5.06 | 28.70 | 48.86 |
| d9 | 9.25 | 11.39 | 12.84 |
| d11 | 15.00 | 4.47 | 0.89 |
| d15 | 34.16 | 18.92 | 0.88 |
| d25 | 2.04 | 2.81 | 2.04 |
| d28 | 21.94 | 21.16 | 21.93 |
| d30 | 2.83 | 4.40 | 2.30 |
| d32 | 8.52 | 6.95 | 9.05 |
| d34 | 37.98 | 37.98 | 37.98 |

Zoom Lens Unit Data

| Lens Unit | Starting Surface | Focal Length |
|---|---|---|
| 1 | 1 | 145.02 |
| 2 | 6 | −154.47 |
| 3 | 10 | −78.37 |
| 4 | 12 | −922.61 |
| 5 | 16 | 37.30 |
| 6 | 26 | −50.98 |
| 7 | 29 | 58.17 |
| 8 | 31 | −46.40 |
| 9 | 33 | 120.30 |

### Numerical Example 3

UNIT: mm
Surface Data

| Surface No. | r | d | nd | vd |
|---|---|---|---|---|
| 1 | 134.111 | 1.60 | 1.72047 | 34.7 |
| 2 | 80.218 | 10.14 | 1.43875 | 94.7 |
| 3 | −775.327 | 0.18 | | |
| 4 | 75.023 | 8.68 | 1.43875 | 94.7 |
| 5 | 532.216 | (variable) | | |
| 6 | 445.813 | 3.44 | 1.69895 | 30.1 |
| 7 | −294.830 | 0.14 | | |
| 8 | 175.033 | 1.40 | 1.59522 | 67.7 |
| 9 | 38.588 | 11.66 | | |
| 10 | −57.616 | 1.40 | 1.49700 | 81.5 |
| 11 | 177.597 | (variable) | | |
| 12 | 57.526 | 3.30 | 2.00069 | 25.5 |
| 13 | 196.444 | 3.20 | | |
| 14 | −65.414 | 1.60 | 1.57099 | 50.8 |
| 15 | 182.032 | (variable) | | |
| 16* | 43.266 | 6.86 | 1.49700 | 81.5 |
| 17* | −103.574 | 1.92 | | |
| 18 (aperture stop) | ∞ | 1.93 | | |
| 19 | 412.522 | 1.40 | 1.77047 | 29.7 |
| 20 | 43.078 | 3.08 | | |
| 21 | 49.136 | 1.20 | 1.77047 | 29.7 |
| 22 | 31.252 | 7.46 | 1.61881 | 63.9 |
| 23* | −135.299 | 0.47 | | |
| 24* | 78.279 | 3.95 | 1.61881 | 63.9 |
| 25* | −237.452 | (variable) | | |
| 26 | −1018.157 | 2.90 | 1.92286 | 20.9 |
| 27 | −62.570 | 1.30 | 1.72342 | 38.0 |
| 28 | 34.675 | (variable) | | |
| 29 | 81.801 | 8.05 | 1.72916 | 54.7 |
| 30 | −54.353 | (variable) | | |
| 31 | −54.656 | 1.47 | 1.62230 | 53.2 |
| 32 | 114.890 | (variable) | | |
| image plane | ∞ | | | |

Aspheric Data
16th Surface
K = 0.00000e+00 A4 = −4.04995e−06 A6 = −3.31752e−10 A8 = −3.57838e−12
17th Surface
K = 0.00000e+00 A4 = −2.08588e−06 A6 = 3.00429e−09 A8 = −4.27630e−12
23rd Surface
K = 0.00000e+00 A4 = 1.29005e−06 A6 = 7.58678e−10 A8 = −1.43134e−12
24th Surface
K = 0.00000e+00 A4 = −5.91443e−06 A6 = −8.87417e−11 A8 = 9.37729e−12
25th Surface
K = 0.00000e+00 A4 = −6.13202e−06 A6 = 2.47877e−10 A8 = 6.96779e−12
A10 = −1.05276e−15
Various Data

| | |
|---|---|
| Zoom Ratio | 2.69 |

| | Wide-Angle | Intermediate | Telephoto |
|---|---|---|---|
| Focal Length | 72.11 | 117.88 | 194.01 |
| FNo | 2.90 | 2.90 | 2.90 |
| Half Angle of View (°) | 16.70 | 10.40 | 6.36 |
| Image Height | 21.64 | 21.64 | 21.64 |
| Overall Lens Length | 217.42 | 217.42 | 217.42 |
| BF | 40.87 | 40.95 | 44.89 |
| d5 | 1.81 | 26.40 | 48.14 |
| d11 | 21.73 | 7.45 | 1.12 |
| d15 | 26.69 | 16.38 | 0.98 |
| d25 | 5.29 | 5.31 | 1.30 |
| d28 | 25.52 | 25.50 | 29.51 |
| d30 | 6.77 | 6.68 | 2.74 |
| d32 | 40.87 | 40.95 | 44.89 |

Zoom Lens Unit Data

| Lens Unit | Starting Surface | Focal Length |
|---|---|---|
| 1 | 1 | 135.06 |
| 2 | 6 | −49.11 |
| 3 | 12 | 709.83 |
| 4 | 16 | 42.74 |
| 5 | 26 | −53.85 |
| 6 | 29 | 45.93 |
| 7 | 31 | −59.32 |

### Numerical Example 4

UNIT: mm
Surface Data

| Surface No. | r | d | nd | vd |
|---|---|---|---|---|
| 1 | 352.733 | 6.02 | 1.48749 | 70.2 |
| 2 | ∞ | 0.20 | | |
| 3 | 161.012 | 10.18 | 1.43387 | 95.1 |
| 4 | −24395.615 | 20.51 | | |
| 5 | 124.191 | 12.26 | 1.43875 | 94.7 |
| 6 | −416.630 | 2.00 | 1.61340 | 44.3 |
| 7 | 135.078 | (variable) | | |
| 8 | 777.435 | 4.28 | 1.62004 | 36.3 |
| 9 | −228.593 | (variable) | | |
| 10 | 134.114 | 1.80 | 1.59410 | 60.5 |
| 11 | 49.127 | 8.10 | | |
| 12 | −115.558 | 1.80 | 1.59410 | 60.5 |
| 13 | 468.402 | (variable) | | |
| 14 | 90.032 | 2.94 | 1.85478 | 24.8 |
| 15 | 228.662 | 4.89 | | |
| 16 | −67.711 | 1.60 | 1.59522 | 67.7 |
| 17 | −309.202 | (variable) | | |
| 18* | 43.441 | 10.01 | 1.49700 | 81.5 |
| 19* | −150.947 | 9.14 | | |
| 20 (aperture stop) | ∞ | 6.75 | | |
| 21 | 723.463 | 1.40 | 1.80610 | 40.9 |
| 22 | 41.374 | 3.22 | | |
| 23 | 61.014 | 1.20 | 1.85478 | 24.8 |
| 24 | 36.303 | 7.42 | 1.76450 | 49.1 |
| 25* | −195.224 | 0.48 | | |
| 26 | 35.968 | 6.42 | 1.43875 | 94.7 |
| 27 | −480.116 | (variable) | | |
| 28 | 144.255 | 2.62 | 1.94594 | 18.0 |
| 29 | −268.421 | 1.30 | 1.90043 | 37.4 |
| 30 | 32.274 | (variable) | | |
| 31* | 1374.090 | 5.12 | 1.85400 | 40.4 |
| 32* | −55.133 | (variable) | | |
| 33 | −65.563 | 1.30 | 1.59522 | 67.7 |
| 34 | 49.807 | (variable) | | |
| 35 | 59.292 | 6.15 | 2.00100 | 29.1 |
| 36 | −463.861 | 1.20 | 1.94594 | 18.0 |
| 37 | 112.541 | (variable) | | |
| image plane | ∞ | | | |

Aspheric Data
18th Surface
K = 0.00000e+00 A4 = −8.16007e−07 A6 = −4.16757e−10 A8 = −1.29761e−13
19th Surface
K = 0.00000e+00 A4 = 1.05337e−06 A6 = −5.99226e−10 A8 = 2.73848e−13
25th Surface
K = 0.00000e+00 A4 = 6.05418e−07 A6 = 3.58203e−10 A8 = −5.59395e−13
31st Surface
K = 0.00000e+00 A4 = 1.76915e−06 A6 = −2.56191e−10 A8 = −4.45134e−13
32nd Surface
K = 0.00000e+00 A4 = 1.17015e−06 A6 = −6.72420e−10 A8 = −5.95424e−13
A10 = 1.63998e−16
Various Data

| | |
|---|---|
| Zoom Ratio | 2.97 |

| | Wide-Angle | Intermediate | Telephoto |
|---|---|---|---|
| Focal Length | 98.00 | 168.99 | 291.00 |
| FNo | 2.90 | 2.90 | 2.90 |
| Half Angle of View (°) | 12.45 | 7.30 | 4.25 |
| Image Height | 21.64 | 21.64 | 21.64 |
| Overall Lens Length | 317.42 | 317.42 | 317.42 |
| BF | 38.00 | 38.00 | 38.00 |
| d7 | 5.76 | 46.62 | 79.10 |
| d9 | 0.98 | 8.11 | 16.76 |
| d13 | 8.79 | 1.68 | 1.14 |
| d17 | 82.43 | 41.55 | 0.96 |
| d27 | 2.04 | 2.80 | 0.89 |
| d30 | 26.48 | 25.71 | 27.62 |
| d32 | 5.23 | 5.67 | 2.39 |
| d34 | 7.39 | 6.95 | 10.24 |
| d37 | 38.00 | 38.00 | 38.00 |

Zoom Lens Unit Data

| Lens Unit | Starting Surface | Focal Length |
|---|---|---|
| 1 | 1 | 316.23 |
| 2 | 8 | 285.37 |
| 3 | 10 | −69.48 |
| 4 | 14 | −1334.01 |
| 5 | 18 | 49.29 |
| 6 | 28 | −48.08 |
| 7 | 31 | 62.17 |
| 8 | 33 | −47.35 |
| 9 | 35 | 109.72 |

### Numerical Example 5

UNIT: mm
Surface Data

| Surface No. | r | d | nd | vd |
|---|---|---|---|---|
| 1 | 248.051 | 7.06 | 1.49700 | 81.5 |
| 2 | ∞ | 0.20 | | |
| 3 | 170.105 | 8.84 | 1.43387 | 95.1 |
| 4 | 14541.336 | 8.10 | | |
| 5 | 135.007 | 10.08 | 1.43875 | 94.7 |
| 6 | −1332.063 | 2.00 | 1.61340 | 44.3 |
| 7 | 148.757 | (variable) | | |
| 8 | 410.912 | 3.03 | 1.61340 | 44.3 |
| 9 | −1104.902 | 1.00 | | |
| 10 | 100.412 | 1.80 | 1.59410 | 60.5 |
| 11 | 44.919 | 8.72 | | |
| 12 | −159.344 | 1.80 | 1.59410 | 60.5 |
| 13 | 185.938 | (variable) | | |
| 14 | 75.783 | 3.08 | 1.85478 | 24.8 |
| 15 | 184.071 | 9.68 | | |
| 16 | −85.628 | 1.60 | 1.59522 | 67.7 |
| 17 | 402.876 | (variable) | | |
| 18* | 47.056 | 8.00 | 1.43875 | 94.7 |
| 19* | −179.498 | 20.28 | | |
| 20 (aperture stop) | ∞ | 2.02 | | |
| 21 | 285.759 | 1.40 | 1.80610 | 40.9 |
| 22 | 48.976 | 2.45 | | |
| 23 | 58.468 | 1.20 | 1.85478 | 24.8 |
| 24 | 36.182 | 7.58 | 1.69350 | 53.2 |
| 25* | −144.615 | 0.48 | | |
| 26 | 39.588 | 5.36 | 1.43875 | 94.7 |
| 27 | 1212.238 | (variable) | | |
| 28 | 422.839 | 2.11 | 1.94594 | 18.0 |
| 29 | −174.640 | 2.00 | | |
| 30 | −175.439 | 2.00 | 1.77250 | 49.6 |
| 31 | 34.442 | (variable) | | |
| 32 | −91.520 | 2.00 | 1.67270 | 32.1 |
| 33 | −675.283 | 5.15 | | |
| 34* | 94.292 | 4.67 | 1.69350 | 53.2 |
| 35* | −75.502 | (variable) | | |
| 36 | −165.767 | 2.00 | 1.59522 | 67.7 |
| 37 | 41.150 | 2.00 | | |
| 38 | 43.492 | 2.00 | 1.61340 | 44.3 |
| 39 | 58.293 | (variable) | | |
| 40 | 95.195 | 4.86 | 1.77047 | 29.7 |
| 41 | −219.350 | 1.20 | 1.94594 | 18.0 |
| 42 | 1063.768 | (variable) | | |
| image plane | ∞ | | | |

Aspheric Data
18th Surface
K = 0.00000e+00 A4 = −7.06274e−07 A6 = −4.14704e−10 A8 = 1.77035e−13
19th Surface
K = 0.00000e+00 A4 = 7.46097e−07 A6 = −4.07505e−10 A8 = 3.51179e−13
25th Surface
K = 0.00000e+00 A4 = 6.81748e−07 A6 = 9.43138e−11 A8 = −2.02463e−13
34th Surface
K = 0.00000e+00 A4 = 1.88299e−06 A6 = −1.59021e−09 A8 = 3.33089e−12
35th Surface
K = 0.00000e+00 A4 = 1.13805e−06 A6 = −1.57268e−09 A8 = 4.46558e−12
A10 = −2.58389e−15
Various Data

| | |
|---|---|
| Zoom Ratio | 3.82 |

| | Wide-Angle | Intermediate | Telephoto |
|---|---|---|---|
| Focal Length | 101.97 | 199.46 | 389.88 |
| FNo | 4.10 | 4.10 | 4.10 |
| Half Angle of View (°) | 11.98 | 6.19 | 3.18 |
| Image Height | 21.64 | 21.64 | 21.64 |
| Overall Lens Length | 359.04 | 359.04 | 359.04 |
| BF | 52.64 | 52.64 | 52.64 |
| d7 | 3.96 | 58.99 | 102.97 |
| d13 | 8.50 | 4.12 | 7.62 |
| d17 | 99.13 | 48.48 | 0.99 |
| d27 | 2.04 | 2.99 | 1.82 |
| d31 | 14.41 | 13.46 | 14.63 |
| d35 | 2.10 | 7.63 | 3.81 |
| d39 | 30.55 | 25.02 | 28.84 |
| d42 | 52.64 | 52.64 | 52.64 |

Zoom Lens Unit Data

| Lens Unit | Starting Surface | Focal Length |
|---|---|---|
| 1 | 1 | 260.97 |
| 2 | 8 | −81.45 |
| 3 | 14 | −1000.36 |
| 4 | 18 | 52.87 |
| 5 | 28 | −53.67 |
| 6 | 32 | 92.19 |
| 7 | 36 | −69.26 |
| 8 | 40 | 155.14 |

Table 1 below summarizes various values in each numerical example.

TABLE 1

| | | Numerical Example | | | | |
|---|---|---|---|---|---|---|
| | | 1 | 2 | 3 | 4 | 5 |
| Inequality (1) | fLF1/ft | 1.179 | 0.747 | 0.696 | 1.087 | 0.669 |
| Inequality (2) | βLMw | −0.939 | −0.608 | −0.834 | −0.557 | −0.503 |
| Inequality (3) | βLMt | −2.165 | −1.656 | −3.324 | −1.953 | −1.882 |
| Inequality (4) | βLR4t/βLR4w | 1.034 | 1.005 | 1.040 | 1.022 | 0.991 |
| Inequality (5) | DMRw/fw | 0.486 | 0.474 | 0.370 | 0.841 | 0.972 |
| Inequality (6) | DFMt/fLF1 | 0.258 | 0.337 | 0.356 | 0.250 | 0.395 |
| Inequality (7) | fLR1/ft | 0.353 | 0.192 | 0.220 | 0.169 | 0.136 |
| Inequality (8) | fLR2/ft | −0.467 | −0.263 | −0.278 | −0.165 | −0.138 |
| Inequality (9) | fLR3/ft | 0.341 | 0.300 | 0.237 | 0.214 | 0.236 |
| Inequality(10) | fLR4/ft | −0.814 | −0.239 | −0.306 | −0.163 | −0.178 |
| Inequality(11) | skw/fw | 0.190 | 0.527 | 0.567 | 0.388 | 0.516 |
| Inequality(12) | Lt/ft | 1.483 | 1.121 | 1.121 | 1.091 | 0.921 |
| Inequality(13) | (1 − βLR2w²)βLR2Rw²/Fnow | −0.798 | −1.372 | −0.997 | −1.607 | −1.692 |
| Inequality(14) | (1 − βLR4w²)βLR4Rw²/Fnow | −0.339 | −0.786 | −0.651 | −0.754 | −0.653 |
| Inequality(15) | DLR1/fw | 0.596 | 0.447 | 0.392 | 0.470 | 0.478 |
| Inequality(16) | TLR2/fw | 0.063 | 0.057 | 0.058 | 0.040 | 0.040 |
| Inequality(17) | DLR3/fw | 0.128 | 0.072 | 0.112 | 0.052 | 0.116 |
| Inequality(18) | TLR4/fw | 0.018 | 0.018 | 0.020 | 0.013 | 0.039 |

### Image Pickup Apparatus

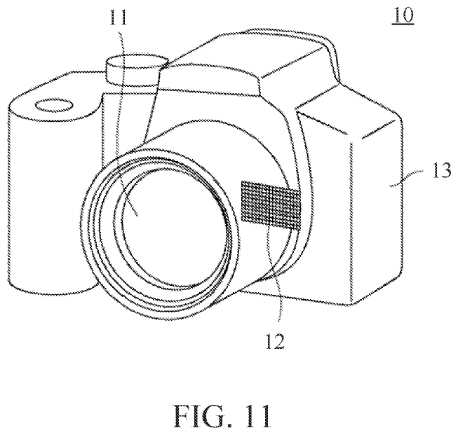

Referring now to FIG. 11, a description will be given of a digital still camera (image pickup apparatus) using the zoom lens L0 according to each example of the disclosure as an imaging optical system. FIG. 11 illustrates the configuration of the image pickup apparatus 10. In FIG. 11, an image pickup apparatus 10 includes a camera body 13, a lens apparatus 11 including any one of the zoom lenses L0 according to Examples 1 to 5, and an image sensor (light receiving element) 12 configured to receive and photoelectrically convert an optical image formed by the zoom lens L0. The image sensor 12 is built in the camera body 13. The image sensor 12 can use a solid-state image sensor (photoelectric conversion element) such as a CCD sensor or a CMOS sensor. The lens apparatus 11 and the camera body 13 may be integrated with each other, or the lens apparatus 11 may be attachable to and detachable from the camera body 13. The camera body 13 may be a so-called single-lens reflex camera having a quick turn mirror, or a so-called mirrorless camera without a quick turn mirror.

Applying the zoom lens L0 according to each example to an image pickup apparatus such as a digital still camera can provide an image pickup apparatus 10 having a small size, light weight, and high optical performance.

The image pickup apparatus 10 according to this example is not limited to the digital still camera illustrated in FIG. 11, but is applicable to various image pickup apparatuses such as broadcasting cameras, film-based cameras, surveillance cameras, and the like.

### Imaging System

An imaging system (surveillance camera system) may include the zoom lens L0 according to any one of Examples 1 to 5 and a control unit configured to control the zoom lens L0. The control unit can control the zoom lens so that each lens unit moves as described above during zooming, focusing, and image stabilization. The control unit may not be integrated with the zoom lens L0, and the control unit may be separated from the zoom lens L0. For example, a control unit (control apparatus) remote from a driving unit configured to drive each lens of the zoom lens L0 may include a transmission unit that transmits a control signal (command) for controlling the zoom lens L0. Such a control unit can remotely control the zoom lens L0.

The control unit may include an operation unit such as a controller and a button for remotely operating the zoom lens L0, and may control the zoom lens according to the input of the user to the operation unit. For example, the operation unit may include an enlargement button and a reduction button. A signal may be sent from the control unit to the driving unit of the zoom lens L0 so that in a case where the user presses the enlarge button, the magnification of the zoom lens increases, and in a case where the user presses the reduce button, the magnification of the zoom lens decreases.

The imaging system may also include a display unit such as a liquid crystal panel configured to display information (moving state) about zoom of the zoom lens L0. The information about the zoom of the zoom lens L0 is, for example, the zoom magnification (zoom state) and the moving amount (moving state) of each lens unit. The user can remotely operate the zoom lens L0 through the operation unit while viewing the information about the zoom of the zoom lens L0 displayed on the display unit. The display unit and the operation unit may be integrated by adopting a touch panel or the like.

Each example can provide a zoom lens having a long focal length, a large aperture ratio, a small size, light weight, and high optical performance.

While the disclosure has been described with reference to embodiments, it is to be understood that the disclosure is not limited to the disclosed embodiments. The scope of the following claims is to be accorded the broadest interpretation so as to encompass all such modifications and equivalent structures and functions.

This application claims the benefit of Japanese Patent Application No. 2022-088496, filed on May 31, 2022, which is hereby incorporated by reference herein in its entirety.

What is claimed is:

1. A zoom lens consisting of, in order from an object side to an image side, a front lens unit, an intermediate group, and a rear group,
wherein the front lens unit has positive refractive power,
wherein the intermediate group includes a plurality of lens units and has a negative combined focal length at a wide-angle end,
wherein the rear group includes, in order from the object side to the image side, a first rear lens unit having positive refractive power, a second rear lens unit having negative refractive power, and a third rear lens unit having positive refractive power, and a fourth rear lens unit having negative refractive power,
wherein a distance between adjacent lens units changes during zooming,
wherein during zooming, the front lens unit, the first rear lens unit, and the third rear lens unit are fixed relative to an image plane, and
wherein during focusing, the second rear lens unit moves relative to the image plane.

2. The zoom lens according to claim 1, wherein the following inequality is satisfied:
0.414<fLF1/ft<1.434
where fLF1 is a focal length of the front lens unit, and ft is a focal length of the zoom lens at a telephoto end.

3. The zoom lens according to claim 1, wherein the following inequality is satisfied:
−1.158<βLMw<−0.285
where βLMw is a combined imaging lateral magnification of the intermediate group at the wide-angle end.

4. The zoom lens according to claim 1, wherein the following inequality is satisfied:
−4.158<βLMt<−1.200
where βLMt is a combined imaging lateral magnification of the intermediate group at a telephoto end.

5. The zoom lens according to claim 1, wherein the following inequality is satisfied:
0.966<βLR4t/βLR4w<1.064
where βLR4t is an imaging lateral magnification of the fourth rear lens unit at a telephoto end, and βLR4w is an imaging lateral magnification of the fourth rear lens unit at the wide-angle end.

6. The zoom lens according to claim 1, wherein the following inequality is satisfied:
0.100<DMRw/fw<1.273
where DMRw is a distance on an optical axis from a lens surface closest to the image plane in the intermediate group at the wide-angle end to a lens surface closest to an object of the rear group, and fw is a focal length of the zoom lens at the wide-angle end.

7. The zoom lens according to claim 1, wherein the following inequality is satisfied:
0.177<DFMt/fLF1<0.466
where DFMt is a distance on an optical axis from a lens surface closest to the image plane in the front lens unit at a telephoto end to a lens surface closest to an object in the intermediate group, and fLF1 is a focal length of the front lens unit.

8. The zoom lens according to claim 1, wherein the following inequality is satisfied:
0.050<fLR1/ft<0.461
where fLR1 is a focal length of the first rear lens unit, and ft is a focal length of the zoom lens at a telephoto end.

9. The zoom lens according to claim 1, wherein the following inequality is satisfied:
−0.632<fLR2/ft<−0.060
where fLR2 is a focal length of the second rear lens unit, and ft is a focal length of the zoom lens at a telephoto end.

10. The zoom lens according to claim 1, wherein the following inequality is satisfied:
0.149<fLR3/ft<0.405
where fLR3 is a focal length of the third rear lens unit, and ft is a focal length of the zoom lens at a telephoto end.

11. The zoom lens according to claim 1, wherein the following inequality is satisfied:
−1.14<fLR4/ft<−0.04
where fLR4 is a focal length of the fourth rear lens unit, and ft is a focal length of the zoom lens at a telephoto end.

12. The zoom lens according to claim 1, wherein the following inequality is satisfied:
0.100<skw/fw<0.755
where skw is a distance on an optical axis from a lens surface closest to the image plane of the rear group at the wide-angle end to the image plane, and fw is a focal length of the zoom lens at the wide-angle end.

13. The zoom lens according to claim 1, wherein the following inequality is satisfied:
0.639<Lt/ft<1.764
where Lt is a distance on an optical axis from a lens surface closest to an object in the front lens unit at a telephoto end to the image plane, and ft is a focal length of the zoom lens at the telephoto end.

14. The zoom lens according to claim 1, wherein the following inequality is satisfied:
−2.140<(1−βLR2w²)βLR2Rw²/Fnow<−0.351
where βLR2w is an imaging lateral magnification of the second rear lens unit at the wide-angle end, βLR2Rw is a combined imaging lateral magnification of all lens units disposed on the image side of the second rear lens unit at the wide-angle end, and Fnow is an F-number of the zoom lens at the wide-angle end.

15. The zoom lens according to claim 1, wherein the following inequality is satisfied:
−1.010<(1−βLR4w²)βLR4Rw²/Fnow<−0.115
where βLR4w is an imaging lateral magnification of the fourth rear lens unit at the wide-angle end, βLR4Rw is a combined imaging lateral magnification of all lens units disposed on the image side of the fourth rear lens unit at the wide-angle end, and Fnow is an F-number of the zoom lens at the wide-angle end.

16. The zoom lens according to claim 1, wherein the following inequality is satisfied:
0.290<DLR1/fw<0.697
where DLR1 is a distance on an optical axis from a lens surface closest to an object in the first rear lens unit to a lens surface closest to the image plane of the first rear lens unit, and fw is a focal length of the zoom lens at the wide-angle end.

17. The zoom lens according to claim 1, wherein the following inequality is satisfied:
0.028<TLR2/fw<0.074
where TLR2 is a sum of thicknesses on an optical axis of all lenses of the second rear lens unit, and fw is a focal length of the zoom lens at the wide-angle end.

18. The zoom lens according to claim 1, wherein the following inequality is satisfied:
0.014<DLR3/fw<0.166
where DLR3 is a distance on an optical axis from a lens surface closest to an object in the third rear lens unit to a lens surface closest to the image plane in the third rear lens unit, and fw is a focal length of the zoom lens at the wide-angle end.

19. The zoom lens according to claim 1, wherein the following inequality is satisfied:
0.001<TLR4/fw<0.052
where TLR4 is a sum of thicknesses on an optical axis of all lenses of the fourth rear lens unit, and fw is a focal length of the zoom lens at the wide-angle end.

20. An image pickup apparatus comprising:
the zoom lens according to claim 1; and
an image sensor configured to receive an image formed by the zoom lens.
